(19) United States
(12) Patent Application Publication
(10) Pub. No.: US 2015/0347064 A1
(43) Pub. Date: Dec. 3, 2015

(54) IMAGE FORMING APPARATUS FOR PRINTING TARGET IMAGE DATA RECEIVED FROM A TARGET LOCATION

(71) Applicants: KABUSHIKI KAISHA TOSHIBA, Tokyo (JP); TOSHIBA TEC KABUSHIKI KAISHA, Tokyo (JP)

(72) Inventors: Fumiyuki WATANABE, Kannami (JP); Saravanacoumar DOURECANNOU, T.R. Pattinam (IN); Manoj PILLAI, Bangalore (IN)

(73) Assignees: KABUSHIKI KAISHA TOSHIBA, Tokyo (JP); TOSHIBA TEC KABUSHIKI KAISHA, Tokyo (JP)

(21) Appl. No.: 14/293,824

(22) Filed: Jun. 2, 2014

(51) Int. Cl. G06F 3/12; H04N 1/00; H04L 29/08

(52) U.S. Cl. CPC G06F 3/1228; H04L 67/10; G06F 3/1205; G06F 3/1234; G06F 3/1254; G06F 3/1259; G06F 3/1265; H04N 1/00209; H04N 1/00244; H04N 2201/0094

(57) ABSTRACT

An image forming apparatus includes a printing unit configured to print an image an a sheet, an interface by which location information for target image data is communicated from a requesting device outside the image forming apparatus, and a control unit configured to request the target image data from a location, specified in the location information, and control the printing unit to print an image corresponding to the target image data received from the location.

### FIELD

Embodiments described herein generally relate to techniques for receiving data and printing the data.

### BACKGROUND

In the related art, when a downloadable file which is placed on a network is to be printed, a user downloads the file using a personal computer (PC) and prints the file using a printer driver from an application which is able to open the file.

Therefore, it is necessary for the application which is able to open the file and the printer driver to be installed in the PC. In contrast, there also exists direct printing, which allows for printing without an application or a printer driver.

As one method of the direct printing, a downloaded file is copied, to a device such as a USB memory (USB: Universal Serial Bus) and printing is performed after the USB memory is connected to an image forming apparatus. In another method, the downloaded file is specified and transmitted to the image forming apparatus by inputting an LPR command from a command prompt screen on the PC.

However, whatever the method for printing, it is necessary to temporarily download the file onto the PC. In addition, the former requires a USB memory and it is also necessary to copy the file to the USB memory and to perform mounting onto a Multifunction Peripheral (MFP) and output operations. For the latter, an operation which is not familiar to general users, that is, command input is required.

### DESCRIPTION OF THE DRAWINGS

FIG. 1 is a diagram which illustrates a configuration of a system according to an embodiment.

FIG. 2 is a diagram which illustrates a conceptual configuration of a system according to an embodiment.

FIG. 3 is a diagram which illustrates a display example using a web browser on a PC.

FIG. 4 is a diagram which illustrates an example of a print setting screen using a web browser.

FIG. 5 is a diagram which illustrates a display example and an input example using email on a PC.

FIG. 6 is a diagram which illustrates another aspect of a display example and an input example using email on a PC.

FIG. 7 is an example of a case which includes print setting items as well as a display example and an input example using email on a PC.

FIG. 8 is a flowchart which illustrates an operational example using a web browser.

FIG. 9 is a flow chart which illustrates an operation example using email.

### DETAILED DESCRIPTION

In general, according to one embodiment, an image forming apparatus includes a printing unit configured to print an image on a sheet, an interface by which location information for target image data is communicated from a requesting device outside the image forming apparatus, and a control unit configured to request the target image data from a location specified in the location information, and control the printing unit to print an image corresponding to the target image data received from the location.

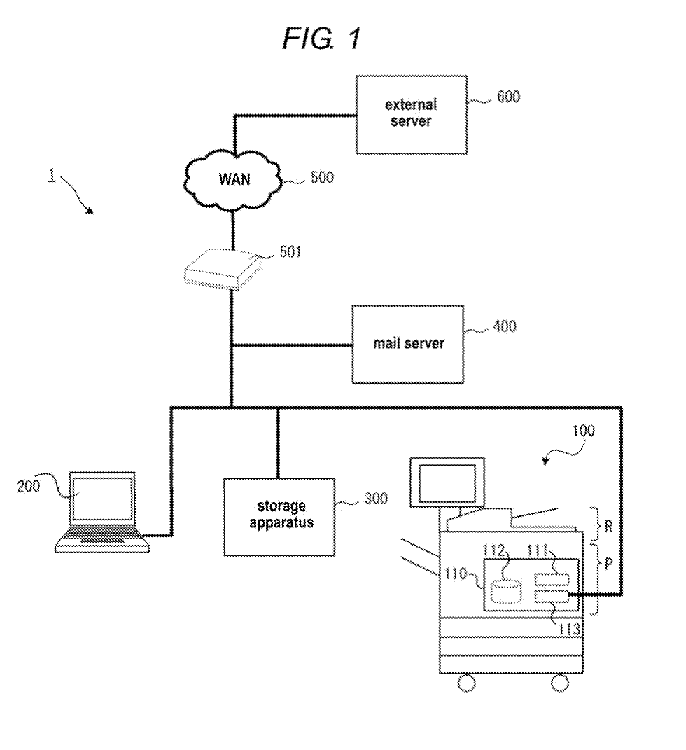

FIG. 1 is a diagram which illustrates a system configuration according to an embodiment. A system 1 includes an image forming apparatus 100, and a PC 200 which is operated by the user.

The image forming apparatus 100 includes a scanning unit R which reads an original sheet by scanning, a printing unit P which forms an image on the sheet, and a control unit 110. The control unit 110 is a unit which performs overall control of each device which is inside the image forming apparatus 100, and includes a processor 111, a storage unit 112, and a network interface 113. The processor 111 is, for example, a Central Processing Unit (CPU), and executes programs which are stored in advance in the storage unit 112. The processor 111 controls each of the devices which are inside the image forming apparatus 100. The storage unit 112 includes a memory which stores in a volatile manner (e.g., RAM), a Hard Disk Drive (HDD) which stores in a non-volatile manner, and the like. The storage unit 112 stores, for example, programs, image data which is read by the scanning unit R, image data for printing which is transmitted from the PC 200, and the like, in a volatile manner or a non-volatile manner. The network interface 113 is, for example, a Network interface Card (NIC), and is a data communication board which conforms to the standard IEEE802.3.

Here, a web server application (referred to below as a web server) and an email acquiring application (referred to below as a mail client) are also loaded into the storage unit 112 in advance.

The PC 200 is a computer which is used by the user, and is equipped with a processor, a storage unit, a network interface, a monitor, a keyboard, and the like. The configuration of the PC 200 is the same as the related art. In addition, a web browser application (referred to below as a web browser) and a mail client are loaded into the storage unit of the PC 200 in advance.

The system 1 includes a storage apparatus 300 and a mail server 400. The storage apparatus 300 is, for example, a Network Attached Storage (NAS), and functions as a file server which accumulates image files, document data, and the like. The mail server 400 is a computer which sends and receives mails (inside ox the outside of the system 1) using a protocol for the sending and receiving of mails (such as SMTP protocol or POP3 protocol). In addition, regions (mail boxes) which accumulate mails delivered to each individual are reserved for each of the users in advance in the mail server 400. In the present embodiment, a mail box of the user who uses the PC 200 or a dedicated mail box for the image forming apparatus 100 is registered, and the user of the PC 200 or the image forming apparatus 100 checks the mail boxes at set time intervals.

The system 1 also includes a router 501. The PC 200 or the image forming apparatus 100 is connected such that communication is possible with a server 600 on the outside via the router SOI and a wide area network 500. The server 600 is an external server which, for example, manages a download site or the like.

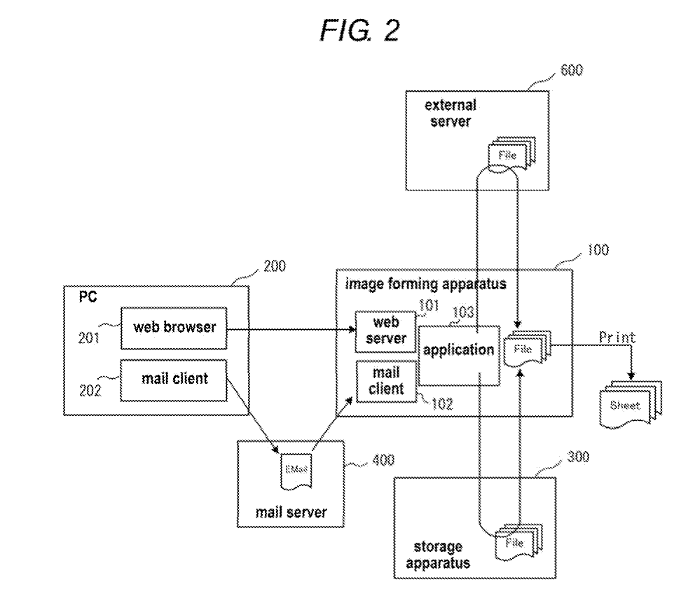

Kent, description will be given of an aspect which performs the direct printing using a web browser or an email while minimizing the work of the user as much as possible. FIG. 2 is a diagram which shows a conceptual configuration of the system 1, and which primarily shows a software configuration.

A web browser 201 and a mail client 202 are loaded into the PC 200 in advance. The web browser 201 displays a screen having a predetermined shape by receiving display data (HTML data) from a web server 101 of the image forming apparatus 100 and transmits the data which is input via the screen to the web server 101. It is possible for the mail client 202 to transmit mail to a mail address for the image forming apparatus 100. As the web browser 201 and the mail client 202, it is possible to use typically used browser applications and mail clients as-is.

The storage unit 112 of the image forming apparatus 100 stores each of the applications of the web server 101, a mail client 102, and an application 103. The application 103 is an application which acquires data from the web server 101 and the mail client 102 and which carries out subsequent processing.

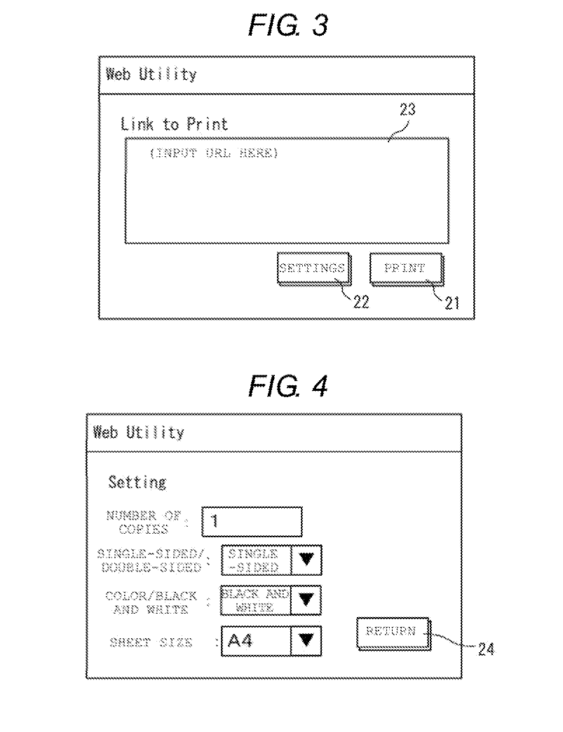

Description will be given of the direct printing according to the embodiment using each piece of software. First, description will be given of web-based direct printing which uses the HTTP protocol. The web browser 201 of the PC 200 displays the screen which is illustrated in FIG. 3 by accessing the web server 101 of the image forming apparatus 100. In area 23, the user inputs the Uniform Resource Locator (URL) of the data file for which printing is desired. The URL describes the server, which stores, holds, and manages the data which is the printing target, and the target data thereof. It is possible to identify the server which is the download destination and the target data using the URL. It is possible for the user to specify one or a plurality of URLs, and the user presses a printing button 21 after inputting the URL(s). Thereby, the text data of the URL is transmitted to the web server 101.

The web server 101 which has received the URL using the network interface 113 passes the text data to the application 103. The method of passing data between the programs and the modules is based on the related art. The application 103 extracts the URL from the received data and downloads the specified files from the external server 600 or the storage apparatus 300 based on the URL. The printing unit P prints the download file under the control of the application 103.

In addition, when a setting button 22 which is illustrated in FIG. 3 is pressed, the web browser 201 displays the setting input screen which is illustrated in FIG. 4 by acquiring HTML data from the web server 101. Using the setting input screen, the user specifies print setting data which defines how the data of the printing target is to be printed. In the present embodiment, it is possible for the user to set and specify, for example, the number of copies to be printed, single-sided or double-sided printing, color or black and white (gray scale), and the sheet size. When the user inputs the print setting items and presses a return button 24, the screen returns to the screen which is illustrated in FIG. 3. Here, when the printing button 21 is pressed, various types of print setting data specified by the user are also transmitted to the web server 101 in the same manner as the URL data. The application 103 controls the printing unit P so as to acquire the file which is specified by the URL and perform printing with the settings according to the print setting data. Here, in the present embodiment, when the printing button 21 is pressed without the setting button 22 being pressed (without displaying the setting screen which is illustrated in FIG. 4), printing is performed with default settings (one copy, single-sided, gray scale, A4 sheet size). Here, the print setting items or the print setting values are only examples.

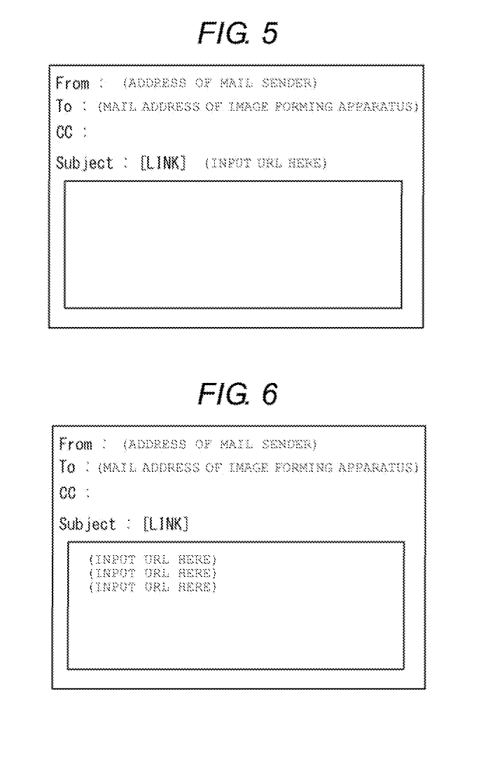

Next, description will be given of the direct printing in a mail base where information is received, in the format of an email. A user transmits the URL (text data) of the desired file with the dedicated mail address of the image forming apparatus 100 as the destination, using the mail client 202 of the PC 200. When specifying the URL, for example, it is possible to input the URL in the mail title (subject) as illustrated in FIG. 5 or to input the URL in the body text as illustrated in FIG. 6. The number of specified URLs may be one or plural. In addition, the user may add a character string “[LINK]” to the beginning of the email title such that it is possible to recognize the URL.

The mail client 102 of the image forming apparatus 100 regularly checks its own mail hex on the mail server 400. Upon receiving a mail, the mail client 102 passes the text data in the mail to the application 103. The application 103 extracts the text ox the URL from the transmitted text data, downloads the file which is specified in the URL from the server 600 or the storage apparatus 300, and prints the download file in the printing unit P.

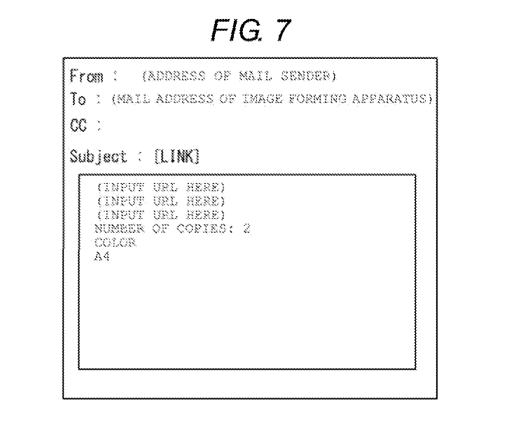

In addition, it is possible for the user to include the print setting data in the body text of the mail. An input example at such a time is illustrated in FIG. 7. The application 103 extracts the print setting data by determining whether or not the character string in the body text of the mail matches keywords which are defined in advance. When there is a matching character string, the application 103 controls the printing in the printing unit P by performing print setting based on the character string. Specifically, the operation is as follows.

1. The application 103 searches for the character string “the number of copies” and when there is a matching line, extracts the value (text) which is written in the line. The application 103 sets the obtained value as the number of copies to be printed. In a case of the example illustrated in FIG. 7, two copies will be printed.

2. The application 103 searches for each character string of “black and white”, “gray scale” and “color” from the mail body text. When there is a matching character string, the application 103 performs print setting which relates to color/black and white according to the extracted character string. For example, gray scale printing will be set when the character strings “black and white” and “gray scale” are present and color printing will be set when the character string “color” is present.

3. The application 103 determines whether or not there is a character string which indicates the sheet sire in the mail body text such as “A4”, “A3” or “Letter”. When a matching character string is detected, the sheet size of the extracted character string will foe set. For example, when the character string “A4” is detected, printing will be performed on an A4 size sheet.

4. The application 103 determines the presence or absence of the character strings “single-sided” and “double-sided” and when one of the character strings is present, performs single-sided/double-sided print setting according to the matching character string. For example, in a case of detecting the character string “double-sided”, double-sided print setting will be applied.

When there is no such specification in the body text, the default setting is followed. For example, when the character string of “single-sided” or “double-sided” is not present as illustrated in FIG. 7, the default setting value (for example, single-sided printing) will be applied. In addition, for example, in cases where character strings with conflicting settings are detected, such as a case where “color” and “black and white” are both specified in the same mail, the character string which is detected first will be adopted in the present embodiment. In addition, formats for the description of the print setting data are not defined in the present example. However, formats for the print setting may be defined in advance. In addition, pattern matching detection, in which variations in notation are taken into consideration, may be performed.

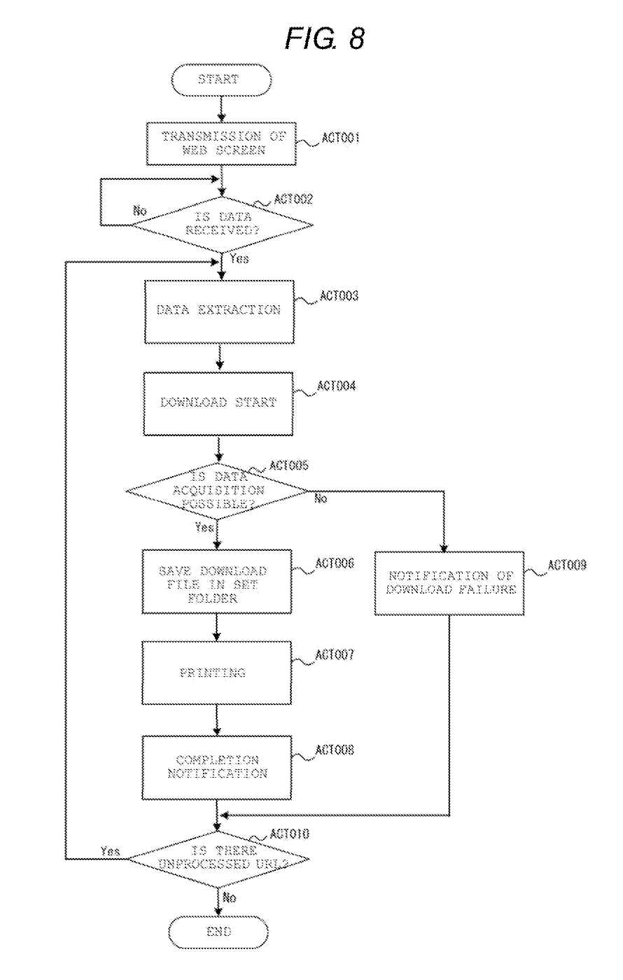

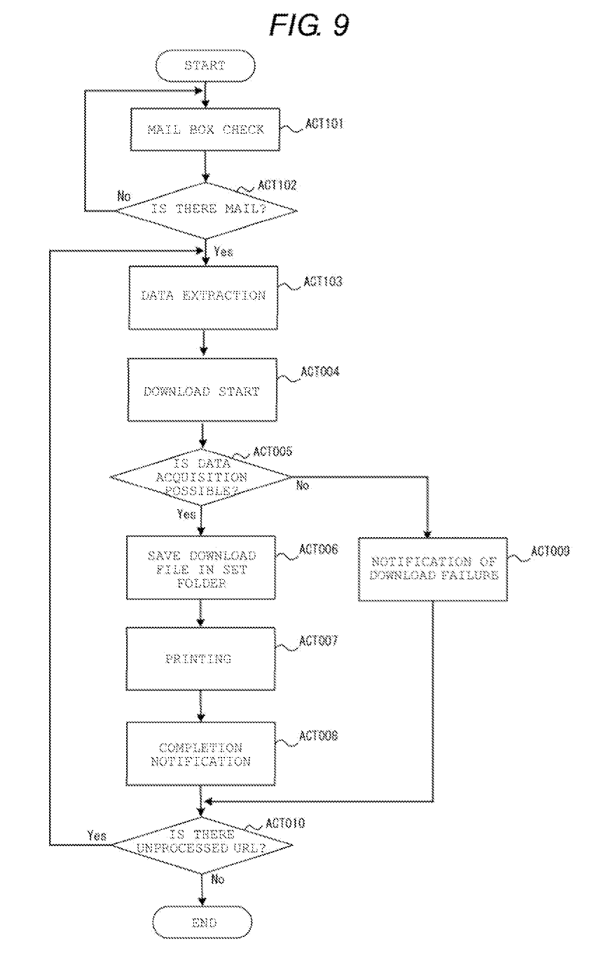

Next, description will be given of an operational example of the image forming apparatus 100 with reference to the flowcharts in FIG. 8 and FIG. 9. The main operational body in the flowcharts illustrated in FIG. 8 and FIG. 9 is the control, unit 110. The processor 111 executes the web server 101, the mail client 102, and the application 103 which are loaded into the storage unit 112 in advance. The operations are performed according to each type of code command.

Description will now be given, of a web-based operational example using FIG. 8. The control unit 110 transmits the web screen which is illustrated in FIG. 3 or FIG. 4 to the PC 200, according to a request from the PC 200 (ACT001). In ACT001, the control unit 110 transmits HTML data or necessary decorative images which are stored in advance in the storage unit 112 to the PC 200.

The control unit 110 stands by until reply data is received (ACT002, loop of No). When the reply data is received (ACT002, Yes), the use protocol, the download destination, and the target file name are extracted from the URL of the reply data. Also, when setting information is attached, the setting values are extracted (ACT003). The use protocol is the protocol which is used at the time of downloading. When the extracted URL begins, for example, with “http:”, downloading is performed using the HTTP protocol because the scheme is HTTP. In addition, when the extracted URL begins with “ftp:”, downloading is performed using FTP protocol because the scheme is FTP. At this time, login authentication is performed using an anonymous account and a set password. In addition, it is also possible to perform secure communication when the extracted URL begins with “https:”. The use protocols which are given here are only examples and a URI scheme other than the above may be specified.

The control unit 110 starts downloading a specified, file from the download site (in the present example, the server 600 or the storage apparatus 300) which is specified by the URL by controlling the network interface 113 (ACT004). At this time, communication is performed using the use protocol which is extracted in ACT003.

In cases where file acquisition is not possible (ACT005, No)—such as a case where the specified file is not in the server 600 or the storage apparatus 300, or a case where communication is not possible—the control unit 110 notifies the PC 200 with a message which indicates download failure by controlling the network interface 113 (ACT009). At this time, the message may be embedded in the set HTML data before being transmitted. The flow proceeds to ACT010 after ACT009.

When file acquisition succeeds (ACT005, Yes), the control unit 110 saves the downloaded file in a folder in the storage unit 112 which has been defined in advance (ACT006), converts the format to data for printing, and sends a printing instruction to the printing unit P (ACT007). When print setting data specified by the user in ACT003 is acquired, the printing unit P performs printing according to the specifications. When the printing is complete, the control unit 110 notifies the PC 200 with a message which indicates printing completion by controlling the network interface 113 (ACT008).

The control unit 110 determines whether there is an unprocessed URL in the received data (ACT010). When there is an unprocessed URL (ACT010, Yes), the flow returns to ACT003 and the control unit 110 continues the process with regard to the unprocessed URL. Here, the notification in. ACT008 and ACT009 may be performed, after the process is complete for all of the URLs.

Next, an operational, example using an email will be illustrated in the flowchart in FIG. 9. The control unit 110 controls the network interface 113, accesses the mail server 400 using a protocol such as POP3, and checks the mail box for the image forming apparatus 100 (ACT101). When there is no mail (ACT102, No), the flow returns to ACT101. The control unit 110 performs the mail checking at set time intervals.

When there is a mail (ACT102, Yes), the control unit 110 extracts the use protocol, the download destination, or the file name from the subject in the email or the URL which is included in the body text. When there is print setting data, the print setting data is extracted (ACT103).

Subsequent operations are the same as in FIG. 8; however, the control unit 110 transmits notification of completion or notification of download failure in ACT008 and ACT009 to the sender of the mail as a reply mail. In addition, the flow returns to ACT101 after ACT010 and the control unit 110 performs the mail checking.

In the present embodiment, description is given using a case where the functions which implement the embodiment are recorded in advance inside the apparatus; however, without being limited thereto, the same functions may be downloaded to the apparatus from a network, or the same functions may foe stored on a recording medium and installed in the apparatus. As long as the recording medium is a recording medium which is able to store programs, such as a CD-ROM, and is able to be read by the apparatus, the recording medium may take any form. In addition, the functions which are obtained by installing or downloading in advance in this manner may achieve functions thereof in cooperation with an OS (Operating System) or the like inside the apparatus.

In the configuration according to the present embodiment, it is possible to perform printing simply by transmitting a URL using a web browser or a mail client which is used on a daily basis. In addition, the image forming apparatus performs printing by directly acquiring the target file from the download destination, which is specified by the URL, without any work on the part of the user. According to this configuration, it is possible to perform the direct printing more easily than with the procedures of the related art.

While certain embodiments have been described, these embodiments have been presented by way of example only, and are not intended to limit the scope of the invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

1. An image forming apparatus comprising:
a print device configured to print an image on a sheet; an interface that:
in response to a request from a requesting device outside the image forming apparatus, sends instructions for displaying a web page to the requesting device, the web page configured to accept input of location information for target image data, and
receives, from a web browser of the requesting device, the by which location information that was input via the web page; and
a controller configured to request and receive the target image data from a location specified in the location information, and control the print device to print an image corresponding to the target image data received from the location.

2. The apparatus according to claim 1, wherein
together with the location information, print setting information is received from the requesting device, and
the controller is further configured to control the print device to print the image corresponding to the target image data according to print settings determined from the print setting information.

3. The apparatus according to claim 2, wherein
the controller is configured to cause a first message which indicates printing completion to be output through the interface to the requesting device when printing of the image corresponding to the target image data is completed, and a second message which indicates a failure to be output through the interface to the requesting device when it is not possible to acquire the target image data.

4. The apparatus according to claim 1, wherein
the controller is further configured to extract, from the location information, a URL of an apparatus that stores the target image data.

5-7. (canceled)

8. The apparatus according to claim 1, wherein
the location information is a URL of the apparatus that stores the target image data.

9. A method of operating an image forming apparatus comprising the steps of:
in response to a request from a requesting device outside the image forming apparatus, sending instructions for displaying a web page to the requesting device, the web page configured to accept input of location information for target image data;
receiving, from a web browser of the requesting device, the location information that was input via the web page;
requesting and receiving the target image data from the location specified in the location information; and
controlling a print device to print an image corresponding to the target image data received from the location.

10. The method according to claim 9, wherein
together with the location information, print setting information is received from the requesting device, and
the print device is controlled to print the image corresponding to the target image data according to print settings determined from the print setting information.

11. The method according to claim 10, wherein
outputting a first message indicating printing completion to the requesting device when printing of the image corresponding to the target image data is completed, and
outputting a second message indicating a failure to the requesting device when it is not possible to acquire the target image data.

12. The method according to claim 9, wherein
the location information is communicated through the interface using an HTTP protocol, and
a URL of an apparatus that stores the target image data is extracted from the location information.

13-14. (canceled)

15. A non-transitory computer readable medium storing instructions causing an image forming apparatus to perform the steps of:
in response to a request from a requesting device outside the image forming apparatus, sending instructions for displaying a web page to the requesting device, the web page configured to accept input of location information for target image data;
receiving, from a web browser of the requesting device, the location information that was input via the web page;
requesting and receiving the target image data from the location specified in the location information; and
controlling a print device of the image forming apparatus to print an image corresponding to the target image data received from the location.

16. The non-transitory computer readable medium according to claim 15, wherein
together with the location information, print setting information is received from the requesting device, and
the printing unit is controlled to print the image corresponding to the target image data according to print settings determined from the print setting information.

17. The non-transitory computer readable medium according to claim 16, wherein the steps performed by the image forming apparatus further include:
outputting a first message which indicates printing completion through the interface to the requesting device when printing of the image corresponding to the target image data is completed, and
outputting a second message which indicates a failure through the interface to the requesting device when it is not possible to acquire the target image data.

18. The non-transitory computer readable medium according to claim 15, wherein
the location information is communicated through the interface using an HTTP protocol, and
a URL of an apparatus that stores the target image data is extracted from the location information.

19-20. (canceled)

21. The image forming apparatus according to claim 1, further comprising: a storage device that stores the instructions for displaying the web page.
